(19) United States
(12) Patent Application Publication
(10) Pub. No.: US 2024/0192170 A1
(43) Pub. Date: Jun. 13, 2024

(54) METHOD OF AND SYSTEM FOR DETECTING AND/OR MONITORING THE GROWTH OF DEFECTS

(71) Applicant: VILLARI HOLDING B.V., Delft (NL)

(72) Inventor: Olivier Constant Orestes Baas, Amsterdam (NL)

(21) Appl. No.: 18/554,434

(22) PCT Filed: Apr. 8, 2022
(86) PCT No.: PCT/EP2022/059537

§ 371 Date: Oct. 6, 2023

(30) Foreign Application Priority Data
Apr. 9, 2021 (EP) 21167728.1

(51) Int. Cl. G01N 27/82

(52) U.S. Cl. CPC G01N 27/82

(57) ABSTRACT

A method of detecting and/or monitoring the forming and/or the growth of defects, in particular cracks or plastic deformation, and/or suspected defects in ferromagnetic structures, such as civil engineering and marine structures, comprises reading, at a first point in time, values of magnetic flux leakage (MFL) from a plurality of magnetometers placed over or near a defect or a suspected defect and storing the values of magnetic flux leakage (MFL). The method further comprises reading values of magnetic flux leakage (MFL) from a plurality of magnetometers at a further point in time, processing the values of the further reading with the values from the earlier reading, and determining the location of a singular point of the defect from the processed further reading.

### CROSS-REFERENCE TO RELATED APPLICATION

This Application is a Section 371 National Stage Application of International Application No. PCT/EP2022/059537, filed Apr. 8, 202 and published as WO 2022/214694 A1 on Oct. 13, 2022, in English, and further claims priority to European patent application no. 21167728.1, filed Apr. 9, 2021, the contents of which are hereby incorporated by reference in their entirety.

### BACKGROUND

Aspects of the invention relate to a method of and a system for detecting and/or monitoring the forming and/or the growth of defects, in particular cracks or plastic deformation, and/or suspected defects in ferromagnetic structures, such as civil engineering and marine structures, comprising reading values of magnetic flux leakage (MFL) from a plurality of magnetometers, placed over or near a defect or a suspected defect, and storing the values of magnetic flux leakage (MFL), typically in a memory that is part of and/or accessible via a controller or computer.

Non-destructive evaluation (NDE) is widely used to inspect objects, such as ships, offshore structures, renewable energy devices, e.g. windmills, bridges, buildings, cranes, railway, cars, machinery, and pipelines, for defects and damage due to corrosion and wear. Defects include cracks, inclusions, lack of fusion, incomplete penetration and porosities. One of the NDE methods is based on the so-called magnetic flux leakage (MFL) in the vicinity of a defect.

A well-known method that is based on MFL is magnetic particle inspection (MPI) for the detection of defects. This method, however, needs the presence and subjective judgment of a surveyor. Therefore, it is preferred to carry out MFL measurements using magnetometers, such as those based on the Hall effect.

As explained in Van der Horst, M. (2018), “On self magnetic flux leakage [SMFL] in support of fatigue crack monitoring in ship and offshore structures: A numerical, experimental, and full-scale application study.”, regular inspection is needed in order to confirm adequate structural integrity throughout the entire service life of a structure. Detected fatigue cracks that are too long for safe operation need to be repaired. Detected cracks of acceptable length need to be at least inspected more frequently. These inspections are costly, time consuming, and hazardous, so additional inspections on top of the periodical regulatory surveys are to be avoided if possible.

In Van der Horst, it is mentioned that “The envisaged crack monitoring system would consist of arrays of Hall effect sensors that are placed on detected cracks, so that their propagation can be monitored without additional inspections. The Hall effect sensors need to be placed at an optimal altitude above the metal surface, balancing between the sensor sensitivity and accompanied costs, and the spatial density of sensors required for accurate crack length characterization. In principle, a crack can be monitored as long as it is underneath the sensor array. However, crack length dependency of the SMFL creates opportunities to estimate the crack length even when it has propagated outside the sensor array.”

### SUMMARY

A method includes reading values of magnetic flux leakage (MFL) from a plurality of magnetometers at a further (later) point in time,
processing the values of the further reading with the values from the earlier reading, and
determining the location of a singular point of the defect from the processed further reading.

The reading of values, e.g. a current or most recent reading, typically contains little or insufficient information at least in that it does not provide an accurate location of a singular point, such as the tip of a crack, at which the defect propagates or forms. It was found that processing the values of MFL of a current reading with the values of MFL of an earlier reading, such as an initial or reference reading or the preceding reading, significantly improves the accuracy of the data relating to the location of a singular point, in particular the tip of the crack, in the current reading and in many cases even enables locating the singular point where this was impossible with existing methods.

Defects can be surface breaking defects, also known as surface defects or surface flaws, and/or non-surface breaking defects, also known as subsurface defects or embedded flaws. Examples of defects include cracks, plastic deformation (which often is an indication or a precursor of a crack), corrosion, and pitting. Suspected defects include indications that a defect is present and include likely or expected defects, such as critical locations in structures that could contain a defect or where a defect is likely to form or originate.

To enable a more accurate distinction between global effects, such as changes in temperature, expansion of materials, and variations in magnetic (background) field, on the one hand and local (smaller) changes, such as defect growth, on the other, it is preferred that the system comprises at least 3 magnetometers, preferably at least 5 magnetometers, preferably at least 10 magnetometers, preferably at least 20 magnetometers, and/or that the magnetometers are arranged in an array (two dimensions) or in a (single) line (one dimension parallel to the surface on which the magnetometers are placed), in particular a straight line and/or that the distance between most, preferably all, of the magnetometers is equal.

The frequency of the reading of values depends on the circumstances, e.g. the expected rate of propagation or the nature of the structure, i.e. a higher expected rate and more critical structures could necessitate more frequent readings. In general, more frequent readings, e.g. one or more readings per day or per hour, generate more data and are generally preferred. As batteries improve, a higher frequencies will be simpler to implement. With low expected rates and/or non-critical structures readings can be less frequent, e.g. weekly, monthly, or even quarterly.

As mentioned, the magnetometers are placed over the (suspected) defect or near the (suspected) defect, e.g. less than 200 mm, preferably less than 100 mm, preferably less than 50, e.g. within 10 mm from the (suspected) defect.

In an embodiment, the values comprise data of MFL in two or more directions, preferably at least in a direction along the defect (provided of course that the direction can be determined) and in a direction perpendicular to the surface of the ferromagnetic structure on which the magnetometers are placed.

In an embodiment, the method comprises the steps of comparing sets of values of MFL in different directions, selecting at least one set, and determining the location of a singular point of the (suspected) defect from the selected set.

If values are read in two or more, e.g. three directions, in case or surface breaking defects, such as cracks, preferably at least in a direction along the defect (Y-direction), perpendicular to the surface of the ferromagnetic structure (X-direction), and perpendicular to the other two (Z-direction), and processed, at least one signal, i.e. set of values read/measured with a plurality of magnetometers in a particular direction, e.g. along the defect, will typically provide a clearer change in sign, in particular from positive to negative, or direction (peak) than the other(s). This signal is then selected to determine the location of a singular point.

The combination of reading values in two or more, e.g. three directions, and arranging the magnetometers in a single dimension, such as a line, in particular a straight line, provides a relatively compact yet effective means for detecting and/or monitoring the forming and/or the growth of defects, in particular cracks or plastic deformation.

In an embodiment, the values of magnetic flux leakage (MFL) are read passively, in particular without actively generating a magnetic field and preferably by reading only permanent magnetization, stress induced magnetization (also known as the magnetoelastic or Villari effect) and/or the Earth magnetic field, which is/are naturally available as a source or origin of magnetism.

In an embodiment, processing the values of the further reading with the values from the earlier reading involves at least one of calculating, preferably for individual magnetometers, preferably for each of the magnetometers individually, a (weighted) moving average of readings at different points in time, a derivative, a difference, a (weighted) mean squared error, a (weighted) least squares error, zero-crossing or similar noise filtering, and signal reduction processing steps, of such readings.

In a preferred example, values from the earlier reading are subtracted from the values of the further reading.

The invention also relates to a system for detecting and/or monitoring the growth of defects, in particular cracks, in ferromagnetic structures, such as civil engineering and marine structures, comprising a plurality of magnetometers and means, such as a controller, for carrying out the method described above.

To enable a more accurate distinction between global effects, such as changes in temperature, expansion of materials, and variations in magnetic (background) field, on the one hand and local (smaller) changes, such as defect growth, on the other, it is preferred that the system comprises at least 3 magnetometers, at least 5 magnetometers, preferably at least 10 magnetometers, preferably at least 20 magnetometers, and/or wherein the magnetometers are arranged in an array or in a line, in particular a straight line, or in parallel (straight) lines and/or wherein the distance between most, preferably all, of the magnetometers is equal.

In principle all existing and future magnetometers are suitable. Examples include magnetometers configured to measure magnetism based on Hall effect, on anisotropic magnetoresistance (AMR), or on fluxgate. It is preferred that the magnetometers measure magnetism in at least two directions, preferably in three directions.

Another embodiment comprises a controller connected to the magnetometers and configured to turn the magnetometers on, i.e. activate the magnetometers, initiate the readings/measurements, and turn the magnetometers off, preferably periodically. In an embodiment, the system comprises a battery and/or an energy generating and/or harvesting device.

In an embodiment, the controller comprises a processor, a memory, e.g. an (E)EPROM on a printed circuit board, that is accessible via the controller.

In another embodiment, the system comprises a transmitter to send data read with the magnetometers to a receiver and wherein the transmitter preferably is based on the Global System for Mobile Communications (GSM), Long Range Low Power (LoRa), Wifi, and other Radio Frequency standards.

In an embodiment, the magnetometers are accommodated in a housing and/or embedded in a surrounding material, which housing and/or embedding is water and/or oil resistant or weather-, water- and/or oilproof. In an embodiment, the controller and/or the transmitter are accommodated in a separate housing, and the controller is connected to the magnetometers, wired or wirelessly.

In an embodiment, the sensor comprises an adhesive layer, e.g. in the form of adhesive tape or a coating, mechanical fasteners and/or one or more magnets to mount the sensor on a metal structure.

The invention also relates to a computer program comprising instructions to cause the system described above to execute the steps of the method described above and to a computer-readable medium having the computer program stored thereon.

### BRIEF DESCRIPTION OF THE DRAWINGS

Aspects of the invention will now be explained in more detail with reference to the Figures, which show preferred embodiments of the present invention.

FIG. 1 schematically shows a system for detecting and/or monitoring the growth of defects.

FIG. 2 shows a specific example of a sensor strip for use in the system of FIG. 1, comprising a plurality of magnetometers.

FIGS. 3 and 4 show the results of readings (FIG. 3) of values of magnetic flux leakage (MFL) with a plurality of magnetometers and the results of processing the readings (FIG. 4).

### DETAILED DESCRIPTION

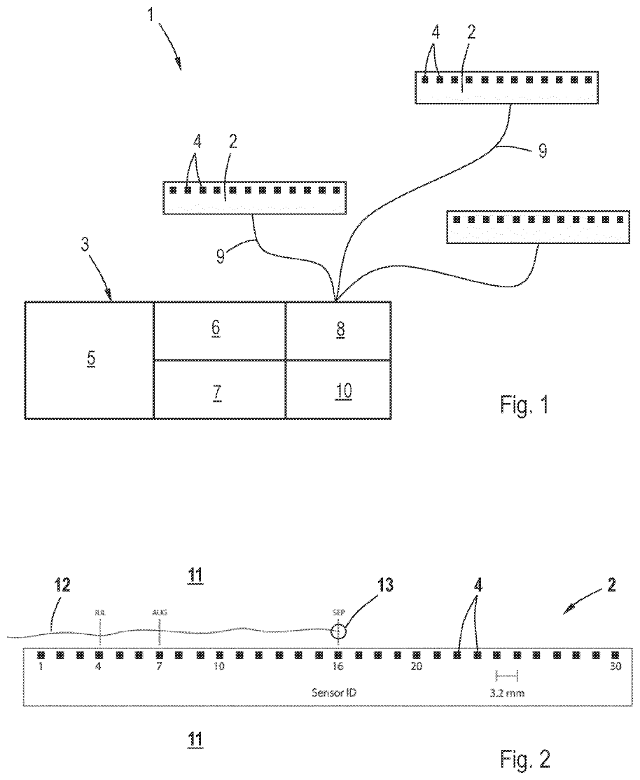

FIG. 1 schematically shows a system 1 for detecting and monitoring the growth of defects, comprising a plurality of sensor strips 2 to be placed over or near a (suspected) defect and a control unit or controller 3 for operating and communicating with the sensor strips. Each strip comprises a plurality of triaxial Hall effect magnetometers 4, preferably at least 3, preferably arranged in a line, in particular a straight line, and has an adhesive surface to attach the strip to a steel structure, such as a civil engineering and marine structure.

In this example, the controller 3 comprises a battery pack 5, a permanent magnet 6 to attach the controller 3 to the steel structure, a controller-board and processor 7, such as a plc, a microcontroller, or a single board computer, connector ports 8 for cables 9 connecting the sensor strips to the controller 3, and a radio frequency (RF) module 10 to communicate with a central computer (not shown).

The controller is configured to turn the magnetometers on, i.e. activate the magnetometers, read values of magnetic flux leakage (MFL) from the plurality of magnetometers in three directions, and turn the magnetometers off. The transmitter is configured to send data read with the magnetometers to a receiver connected to the central computer, e.g. via GSM, LoRa, Wii, or another Radio Frequency standard.

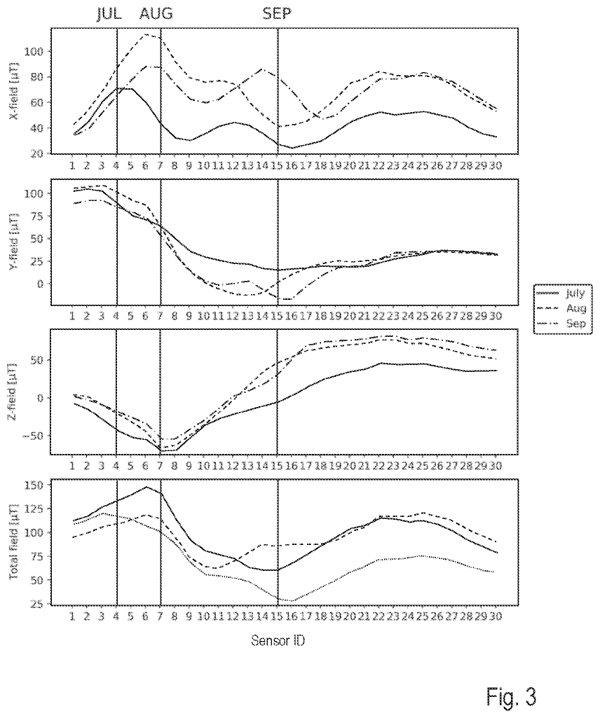

FIG. 2 shows a sensor 2 for carrying out MFL measurements, having 30 triaxial Hall effect magnetometers 4 arranged in a straight line at a consistent center to center separation of 3.2 mm. In FIG. 2, the strip is adhered to a steel structure 11 alongside and essentially parallel to an existing surface breaking crack 12 having a clearly visible singular point, i.c. the tip 13 of the crack 12.

The sensor in FIG. 2 was used to carry out a first reading of values of MFL in three directions, in this example
in the direction in which the crack extended and in the plane of the surface of the structure, in this context also referred to as the Y-direction,
in the direction perpendicular to the Y-direction and perpendicular to the surface of the structure, in this context also referred to as the Z-direction, and
in the direction perpendicular to the direction in which the crack extended and in the plane of the surface of the structure, in this context also referred as the X-direction.

In addition, the total field strength (scalar) at each magnetometer was calculated in the central computer from to the values measured in the three directions.

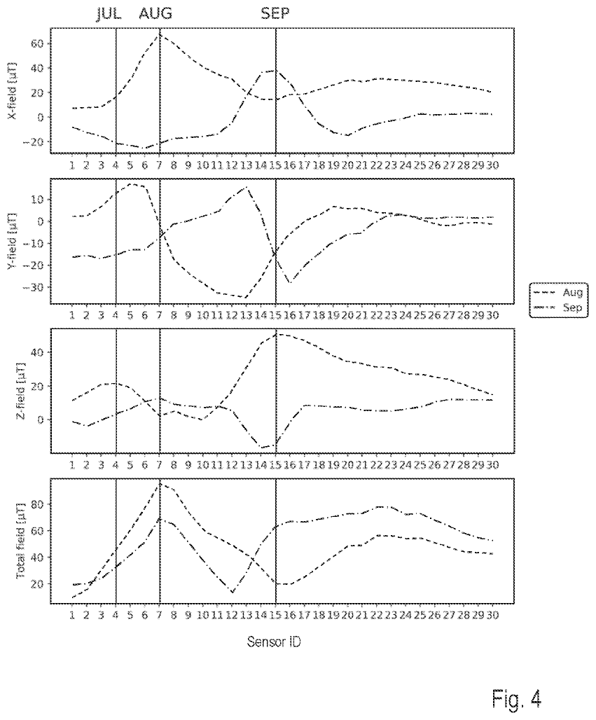

In this example, second and third readings were carried out one month later and two months later, respectively. The results of these readings are shown in FIG. 3, where the first reading is marked “JUL”, the second reading “AUG”, and the third reading “SEP”. In FIG. 3, the locations of the actual tip of the crack at the times of the readings are marked with vertical lines.

The individual readings shown in FIG. 3 contain no or at least insufficient information to accurately located of the tip of the crack.

FIG. 4 shows values of magnetic flux leakage (MFL) from the second and third readings processed with the reading of the first and second readings, respectively. In this example, the values of the first reading were subtracted from the values of the second reading and the values of the second reading were subtracted from the values of the third reading.

The resulting curves of the processed values for MFL in the Y-direction, along the crack, change from a positive value to a negative value at sensors #7 (AUG) and #15 (SEP) and the resulting curves of the processed values for MFL in the X-direction each show a single, distinct peak at the same sensors, #7 (AUG) and #15 (SEP). The position of these sensors corresponded accurately to the actual location of the tip of the crack at the time of the second reading (AUG) and the third reading (SEP), respectively.

Benefits of defect detection and a defect monitoring system based on such measurements are e.g. that the risk level of measured objects can be assessed, that rational decision making on defect repair can be made, and that less frequent inspections can be made by surveyors what translates into less injuries/accidents, and/or significantly reduced costs.

The invention is not restricted to the embodiments described above and can be varied in numerous ways within the scope of the claims. For example, the sensor can be employed to detect new cracks, e.g. by placing sensors on locations where cracks are relatively likely to form.

1. A method of detecting and/or monitoring the forming and/or the growth of defects in structures, comprising
reading values of magnetic flux leakage (MFL) from a plurality of magnetometers placed over or near a defect or a suspected defect, at a first point in time, and
storing the values of magnetic flux leakage (MFL),
reading further values of magnetic flux leakage (MFL) from the plurality of magnetometers at a further point in time,
processing the further values of the further reading with the values from the earlier reading, and
determining the location of a singular point of the defect from the processed further reading.

2. The method according to claim 1, wherein the further readings are carried out at an interval shorter than one week.

3. The method according to claim 2, wherein the values comprise data of MFL in two or more directions.

4. The method according to claim 2, further comprising comparing sets of values of MFL in different directions, selecting at least one set and determining the location of a singular point of the defect from the at least one selected set.

5. The method according to claim 1, wherein the values of magnetic flux leakage (MFL) and the further values of magnetic flux leakage (MFL) are read passively.

6. The method according to claim 1, wherein processing the further values of the further reading with the values from the earlier reading involves at least one of calculating a moving average, a derivative, a difference, a mean squared error, a least squares error, zero-crossing or similar noise filtering and signal reduction processing steps.

7. The method according to claim 1, wherein values from the earlier reading are subtracted from the further values of the further reading.

8. A system for detecting and/or monitoring the growth of defects in structures, comprising:
a plurality of magnetometers; and
means, operably coupled to the plurality of magnetometers for
reading values of magnetic flux leakage (MFL) from the plurality of magnetometers placed over or near a defect or a suspected defect, at a first point in time;
storing the values of magnetic flux leakage (MFL);
reading further values of magnetic flux leakage (MFL) from the plurality of magnetometers at a further point in time;
processing the further values of the further reading with the values from the earlier reading; and
determining the location of a singular point of the defect from the processed further reading.

9. The system according to claim 8 wherein the plurality of magnetometers comprises at least three magnetometers.

10. The system according to claim 8, wherein the plurality of magnetometers are configured to measure magnetism based on Hall effect, on anisotropic magnetoresistance (AMR), or on fluxgate, and/or in at least two directions.

11. The system according to claim 8, wherein said means comprise a controller configured to turn the plurality of magnetometers on, initiate the readings, and turn the plurality of magnetometers off.

12. The system according to claim 8, further comprising a transmitter coupled to the plurality of magnetometers and configured to send data read with the plurality of magnetometers.

13. The system according to claim 1, wherein the plurality of magnetometers are each accommodated in a housing and/or embedded in a surrounding material, which housing and/or embedding is water and/or oil resistant or weather, water- and/or oilproof.

14. The computer program comprising instructions to execute the method of claim 1.

15. The computer-readable medium having stored thereon the instructions of claim 14.

16. The method according to claim 2, wherein the further readings are carried out at the interval of one day or less than 24 hours.

17. The method according to claim 2, wherein the plurality of magnetometers are arranged in an array or a line.

18. The method according to claim 2, wherein distances between adjacent magnetometers of the plurality of magnetometers is equal.

19. The system according to claim 8, wherein the plurality of magnetometers are arranged in an array or a line.

20. The system according to claim 8, wherein distances between adjacent magnetometers of the plurality of magnetometers is equal.
